(19) United States
(12) Patent Application Publication
(10) Pub. No.: US 2018/0326234 A1
(43) Pub. Date: Nov. 15, 2018

(54) Neck Tie Cutter

(71) Applicant: Ronald William Sable, JR., Fayetteville, NC (US)

(72) Inventor: Ronald William Sable, JR., Fayetteville, NC (US)

(21) Appl. No.: 15/976,030

(22) Filed: May 10, 2018

Related U.S. Application Data
(60) Provisional application No. 62/504,374, filed on May 10, 2017.

(51) Int. Cl. A62B 99/00; B26B 3/00

(52) U.S. Cl. CPC A62B 99/00; A41D 25/00; B26B 3/00

(57) ABSTRACT

A safety device, “tie cutter” designed to be worn about the neck on a conventional neck tie and concealed from view by the shirt collar that can quickly sever the neck tie by manually pulling on the device. The tie cutter includes a thin flat body and an embedded blade. The cutter body has generally hour-glass shaped opening defined by a circular “loop” opening and a “blade” opening that merge together through a narrow “throat” opening. The blade is situated so that the sharp beveled edge extends laterally into and across the blade opening opposite the throat opening and the loop opening. The loop opening provides a “tie loop” through which a neck tie is passed when the tie cutter is donned on a neck tie and worn. It also provides a “finger loop” for hooking and pulling the tie cutter with a finger to sever a neck tie from around the wearer's neck.

This application claims the benefit of U.S. Provisional Application No. 62/504,374 filed May 10, 2017, the disclosure of which is hereby incorporated by reference.

This invention relates to a safety device worn with a neck tie, and in particular a neck tie cutter worn about the neck tie for severing the tie from around a wearer's neck.

### BACKGROUND AND SUMMARY OF THE INVENTION

Neck ties are commonly worn with collared shirts as part conventional formal, business and casual attire. During physical altercations and other exigent circumstances, neck ties can become choke hazards to the wearer. In occupations, such as law enforcement and personal security, it is often critical to be able to quickly doff a neck tie to regain or maintain a tactical advantage that may prevent using the tie against the wearer.

This invention provides a convenient safety device designed to be worn about the neck on a conventional neck tie and concealed from view by the shirt collar that can quickly sever the neck tie by manually pulling on the device. The tie cutter of this invention includes a thin flat body and an embedded blade. The cutter body has a generally hour-glass shaped opening defined by a circular “loop” opening and a “blade” opening that merge together through a narrow “throat” opening. The blade is situated so that the sharp beveled edge extends laterally into and across the blade opening opposite the throat opening and the loop opening. The loop opening provides a “tie loop” through which a neck tie is passed when the tie cutter is donned on a neck tie and worn. It also provides a “finger loop” for hooking and pulling the tie cutter with a finger to sever a neck tie from around the wearer's neck. The tie cutter is worn under the collar with the neck tie passing through the loop opening of the cutter body. With the neck tie cinched around the wearer's neck, the tie cutter is held flat against the wearer's neck and concealed by the shirt collar. Manually pulling on the tie cutter forces the neck tie from the loop opening through the narrow throat opening into the blade opening and into contact with the blade, which severs the neck tie releasing it from around the wearer's neck.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of an exemplary embodiment of the neck tie cutter of this invention;

FIG. 2 is another perspective view of the neck tie cutter of FIG. 1;

FIG. 3 is a top view of the neck tie cutter of FIG. 1;

FIG. 4 is a bottom view of the neck tie cutter of FIG. 1;

FIG. 5 is a right side view of the neck tie cutter of FIG. 1;

FIG. 6 is a left side view of the neck tie cutter of FIG. 1;

FIG. 7 is a front view of the neck tie cutter of FIG. 1;

FIG. 8 is a rear view of the neck tie cutter of FIG. 1;

FIG. 9 is a partial top view of a second exemplary embodiment of the neck tie cutter of the invention;

FIG. 10 is a partial top view of a third exemplary embodiment of the neck tie cutter of the invention;

FIG. 11 is a partial top view of a fourth exemplary embodiment of the neck tie cutter of the invention;

FIG. 12 is a perspective view with cutaway potions of the neck tie cutter of FIG. 1 affixed to a neck tie and concealed under a shirt collar;

FIG. 13 is a perspective view of a neck tie passed through the “loop” opening of the neck tie cutter of FIG. 1;

FIG. 14 is a perspective view of a neck tie being pulled through the “throat” opening of the neck tie cutter of FIG. 1;

FIG. 15 a perspective view of a neck tie being severed by the neck tie cutter of FIG. 1;

FIG. 16 is perspective view with cutaway portions of the neck tie cutter of FIG. 1 on a neck tie being manually pulled under a shirt collar;

FIG. 17 is another perspective view with cutaway portions of the neck tie cutter of FIG. 1 on a neck tie being manually pulled under a shirt collar to sever the neck tie;

FIG. 18 is another perspective view with cutaway portions of the neck tie being severed by the neck tie cutter of FIG. 1;

FIG. 19 is a side sectional view of the neck tie cutter of FIG. 1 with a neck tie passed through the “loop” opening thereof;

FIG. 20 is a side sectional view of the neck tie cutter of FIG. 1 with a neck tie being pulled through the “throat” opening and against the blade thereof;

FIG. 21 is a side sectional view of the neck tie cutter of FIG. 1 with the blade slicing through a neck tie; and

FIG. 22 is a side sectional view of the neck tie cutter of FIG. 1 and a severed a neck tie.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

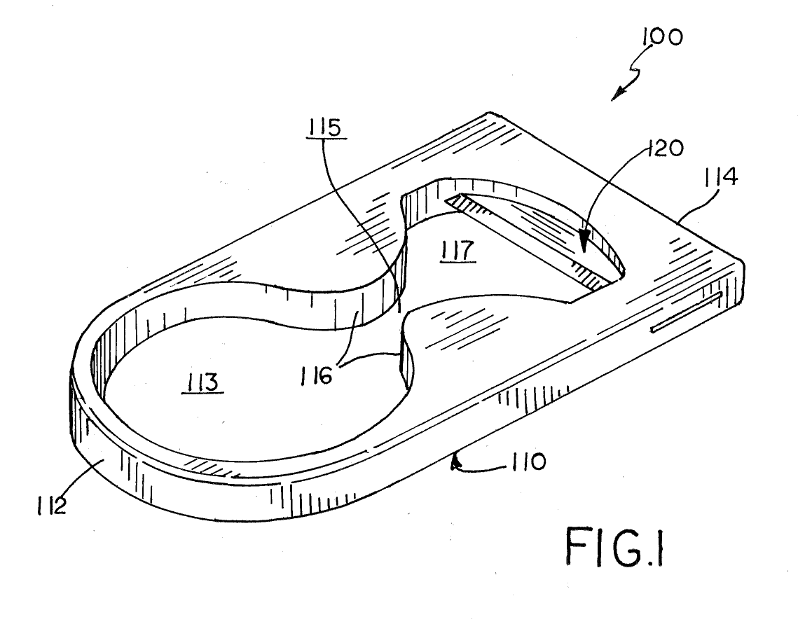

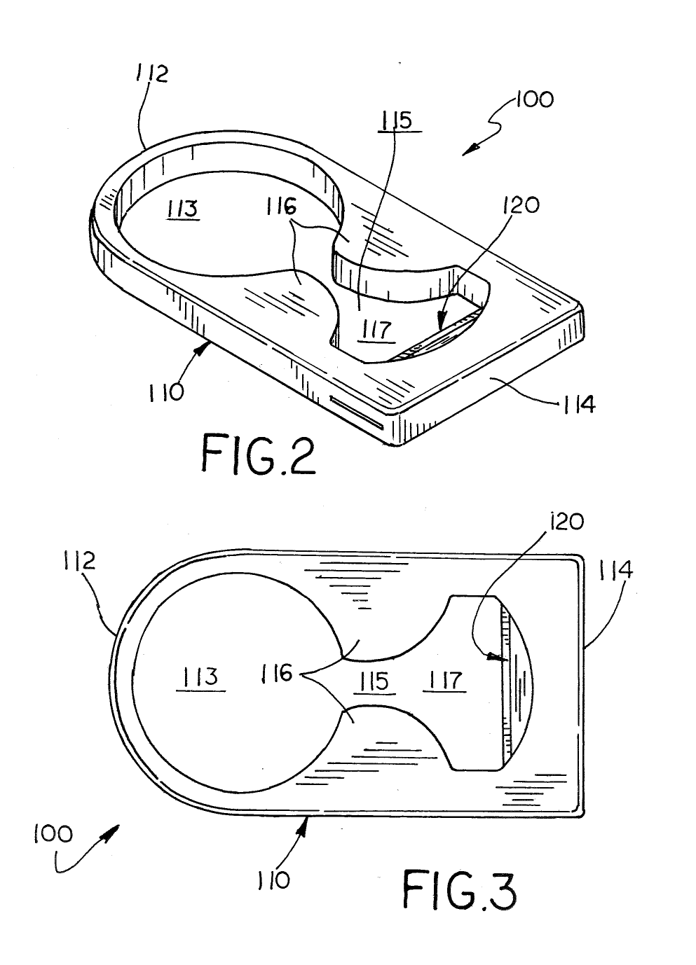

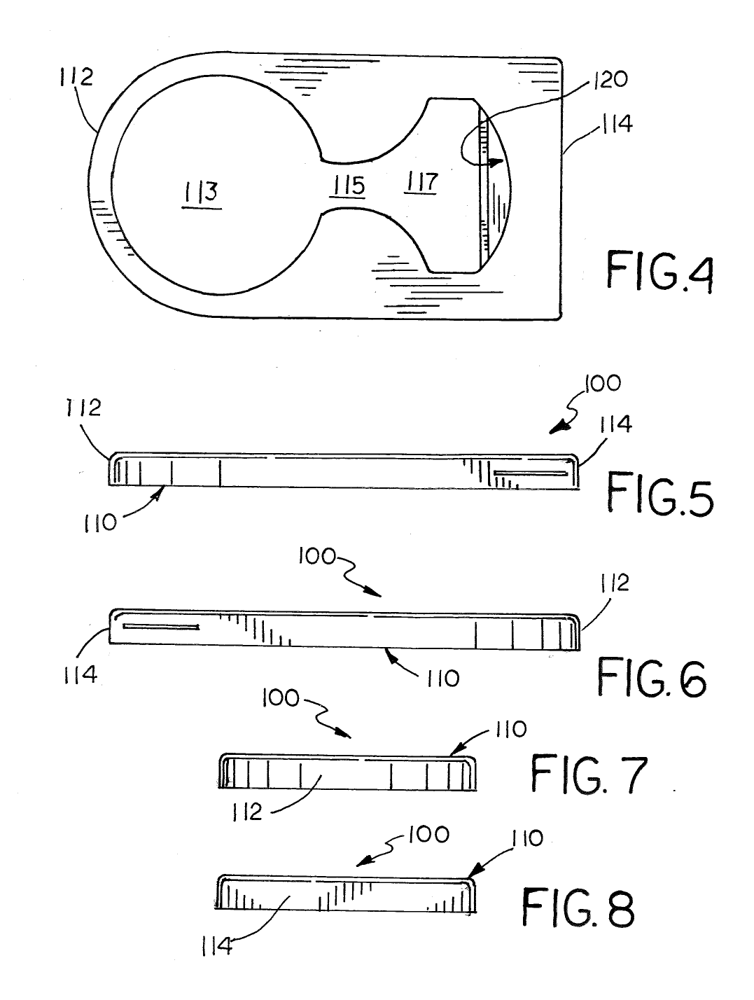

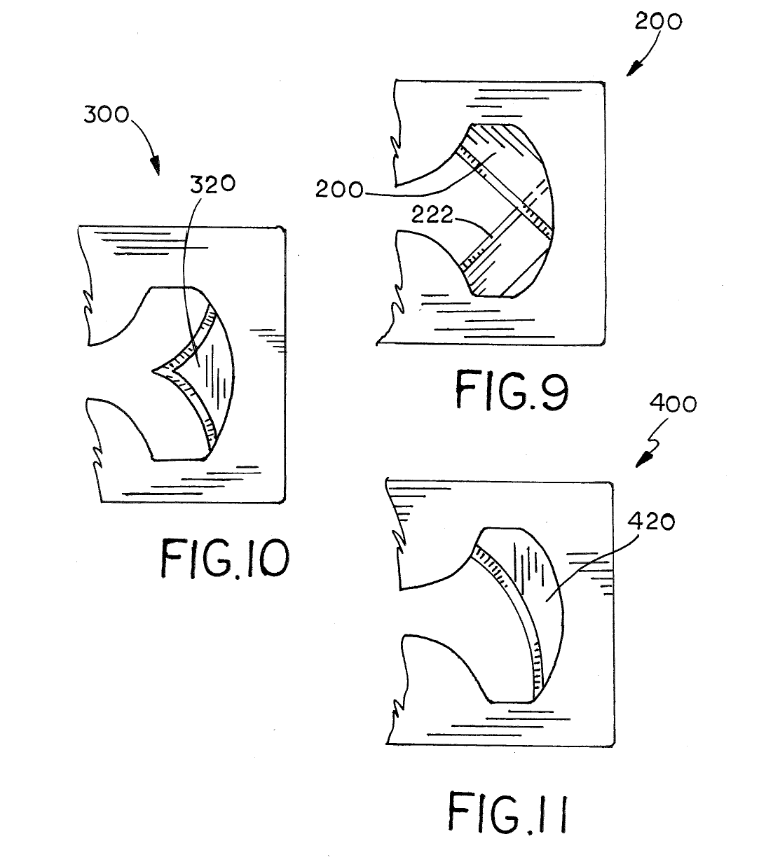

Referring now to the drawings, FIGS. 1-8 illustrate an exemplary embodiment of the neck tie cutter of this invention, which is designated generally as reference numeral 100. Tie cutter 100 is designed to be worn about the neck on a conventional neck tie and concealed from view by the shirt collar. Tie cutter 100 includes a thin flat body 110 and an embedded blade 120 that severs the neck tie when the wearer pulls on the cutter.

Cutter body 110 is generally a single flat piece molded, formed or otherwise constructed of a durable polymer material, such as a fiberglass reinforce plastic. Other embodiments of the cutter body may also be cast, stamped, cut or machined from other suitable materials, such as ceramics and metals. Cutter body 110 is sized and configured to be concealed under the collar of a standard dress shirt. Dimensionally, cutter body 110 has a length of approximately two inches and a width of one and one quarter inches and a thickness less than ⅜ of an inch.

As shown, cutter body 110 has flat top and bottom surfaces and rounded edges to prevent Cutter 100 from snagging on the fabric of a shirt, neck tie or other clothing. Cutter body 110 has a rounded “loop” end 112 and a squared “blade” end 114. Cutter body 110 has a generally hour-glass shaped opening defined by a circular “loop” opening 113 and a “blade” opening 117 that merge together through a narrow “throat” opening 115. Throat opening 115 is formed by a pair of opposed side lobes 116 that extend inward from the sides of cutter body 110 between loop opening 113 and blade opening 115. The configuration of cutter body 110 with the rounded end 112 and loop opening 113 provides a “tie loop” through which a neck tie is passed when tie cutter 100 is donned on a neck tie and worn. It also provides a “finger loop” for hooking and pulling the tie cutter with a finger to manually sever a neck tie from around the wearer's neck.

Blade 120 is typically a small thin ceramic or steel straight blade embedded into the cutter body 110 or fitted and bonded within a thin slit formed in the cutter body. As shown, blade 120 is situated to lie within the central longitudinal plane of cutter body 110. Blade 120 is situated so that the sharp beveled edge extends laterally into and across blade opening 115 opposite throat opening 115 and loop opening 113. Blade opening 117 is dimensioned and configured, so as to generally shield blade 120 and prevent a wearer's fingers from contacting the blade during use.

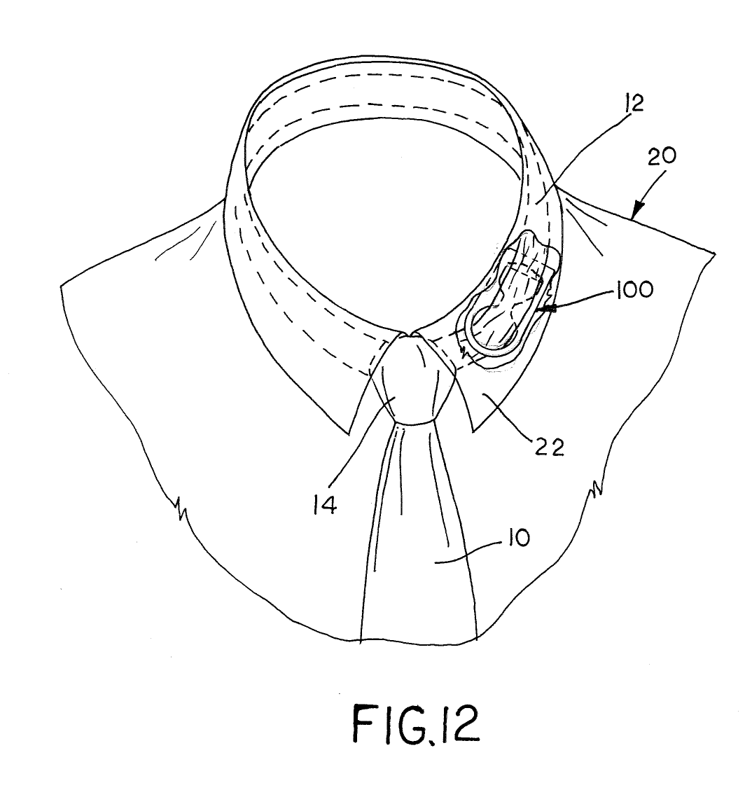

FIGS. 9-10 illustrate alternative embodiments of the tie cutter of this invention using different blade configurations. FIG. 9 illustrates a tie cutter 200 that uses a dual blade configuration where the two separate blades 220 and 222 are embedded within the cutter body and angularly oriented to provide a scissoring action. FIG. 10 illustrates a tie cutter 300 that uses a blade 320 having a cutting edge that is ground to have a central point extending into the blade opening. FIG. 11 illustrates a tie cutter 400 that uses a blade 420 having a curved cutting edge that extends angularly across the blade opening.

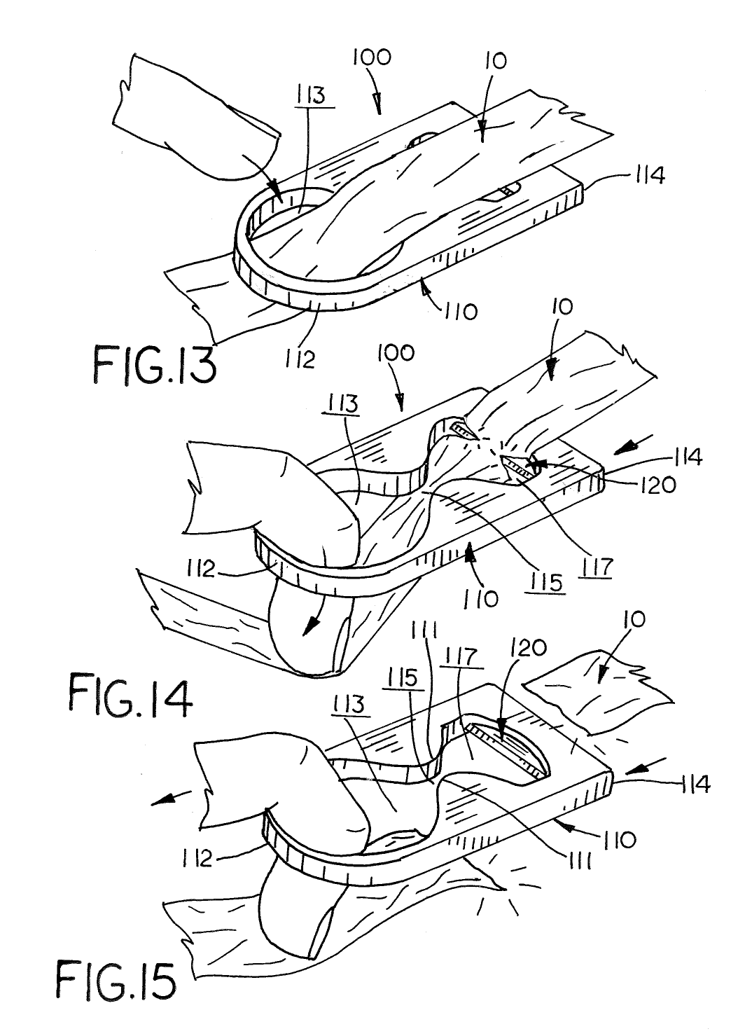

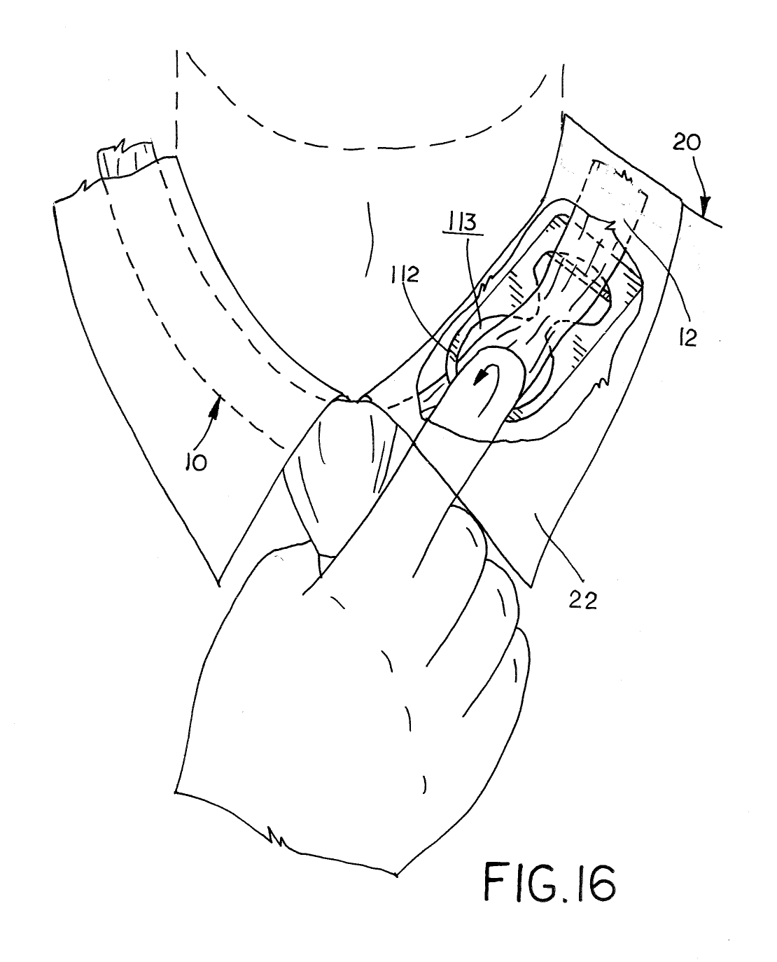

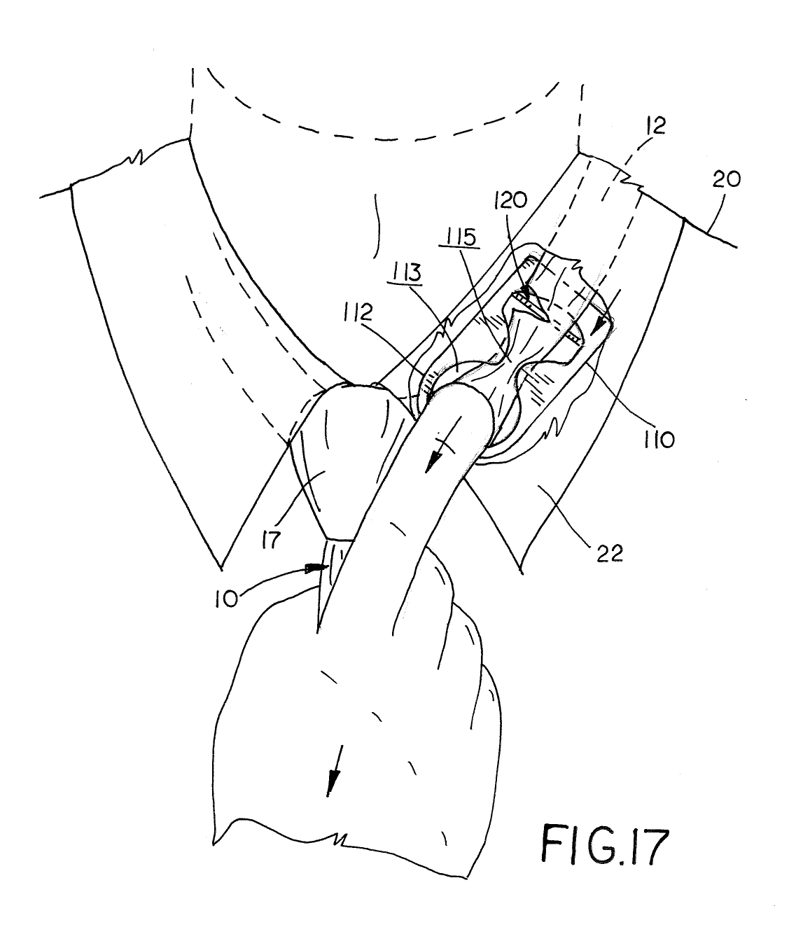

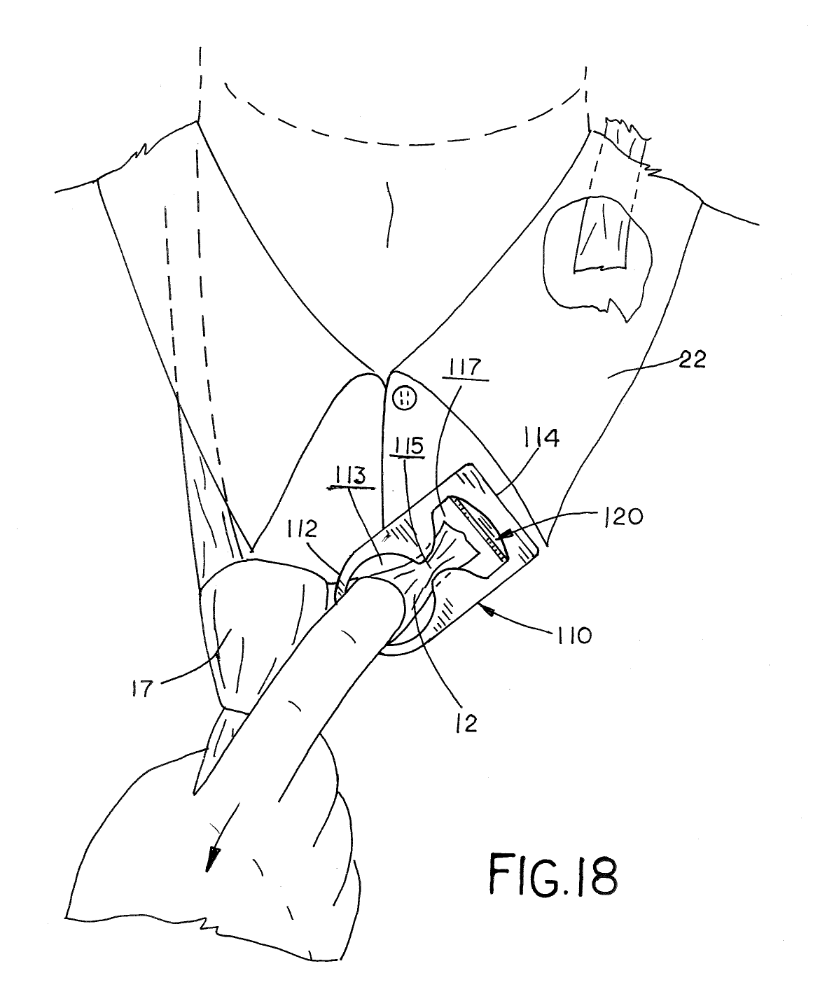

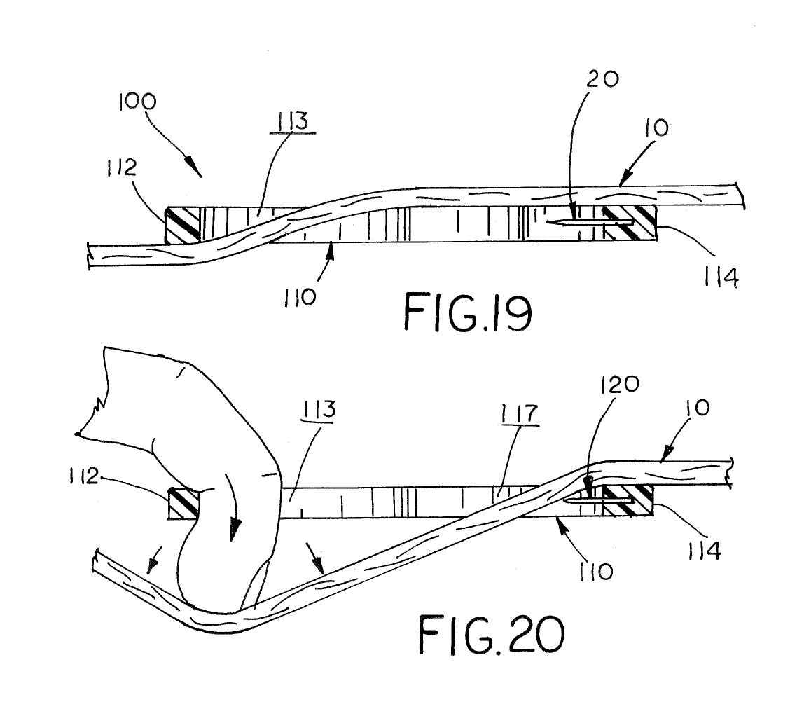

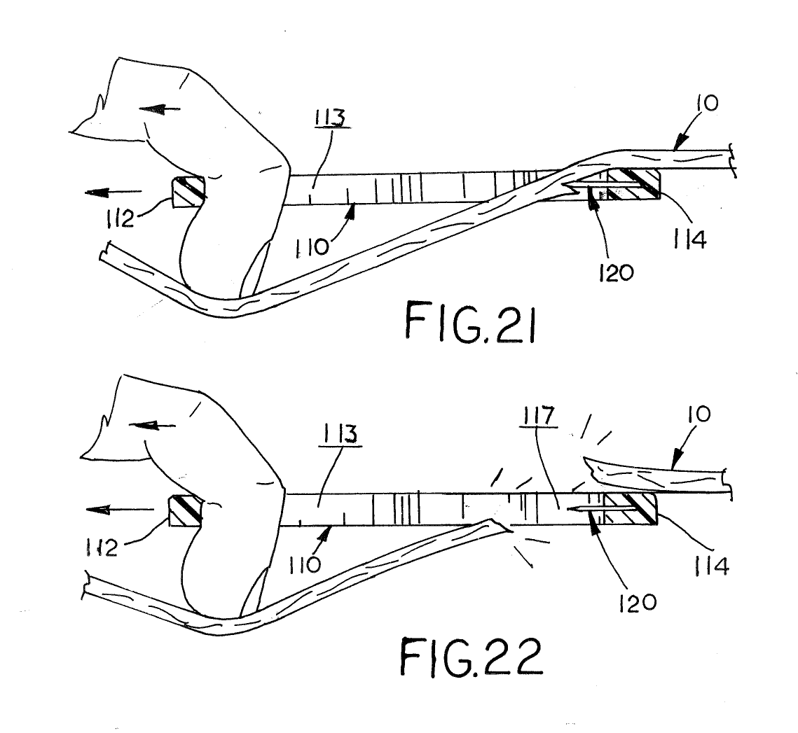

FIGS. 12-22 illustrated how the tie cutter 100 is worn and used with a conventional neck tie 10 and collared shirt 20. Tie cutter 100 is worn under the collar 22 with the neck tie 10 passing through the loop opening 113 of cutter body 110. Neck tie 10 is tied around the wearer's neck with the neck loop of the tie extending through loop opening 113 (FIGS. 12, 13 and 19). As best shown in FIGS. 13 and 19, neck tie 10 passes up through loop opening 113 and overlies throat opening 115, blade opening 117 and the top of cutter body 110. With neck tie 10 passing through loop opening 113 and cinched around the wearer's neck, tie cutter 100 is held flat against the wearer's neck and concealed by shirt collar 22. As best shown in FIG. 12, tie cutter 100 is positioned adjacent the tie knot 14 but is still concealed under shirt collar 22. When donned, the side lobes 116 that form the narrow throat opening 115 prevent neck tie 10 from sliding through the throat opening into blade opening 117 and into contact with blade 120. To sever neck tie 10 from around the neck, the wearer simply reaches under shirt collar 22, hooks the finger through loop opening 113 and pulls down and out on tie cutter 100 (FIGS. 14, 16, 20 and 21). Manually pulling tie cutter 100 down and outward forces neck tie 199 from loop opening 113 through throat opening 115 into blade opening 117. Once inside blade opening 117, pulling on tie cutter 100 forces blade 120 against neck tie 10 severing the fabric (FIGS. 15, 18 and 22).

It should be apparent from the foregoing that the invention has significant novel utility. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1: A safety device for use with a neck tie, comprising:
a flat body; and
a blade disposed within the flat body,
the body having a generally hour-glass opening therethrough defined by a first opening, a second opening and a throat opening extending therebetween, the blade having a cutting edge thereof extending into and across the second opening,
the first opening for receiving therethrough the neck tie when the body is fitted to the neck tie and worn by a wearer, the second opening for forceably receiving the neck tie to contact the blade when the body is manually pulled and sever the neck tie from around the wearer's neck.

2: The safety device of claim 1 wherein the throat opening is configured to allow the neck tie to pass therethrough from the first opening into the second opening when the body is fitted to the neck tie and manually pulled away from the neck tie.

3: The safety device of claim 3 wherein the blade has a curved cutting edge.

4: The safety device of claim 1 wherein the cutting edge extends into and across the second opening parallel to the first opening.

5: The safety device of claim 1 wherein the blade is extends into and across the second opening at an angle with respect to the first opening.

6: The safety device of claim 1 and a second blade disposed within the body and extends into and across the second opening at an angle with respect to the first opening opposite of the first blade.
